(19) United States
(12) Patent Application Publication
(10) Pub. No.: US 2006/0235925 A1
(43) Pub. Date: Oct. 19, 2006

(54) Client-server system and method thereof for providing multimedia and interactive services to mobile terminals

(76) Inventors: Mauro Rossotto, Torino (IT); Maria Lorenza Demarie, Torino (IT); Luca Lattore, Torino (IT); Giuseppe Lo Bello, Torino (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/553,827

(22) PCT Filed: Apr. 23, 2003
(86) PCT No.: PCT/EP03/04206

§ 371 Date: Oct. 20, 2005

(51) Int. Cl. G06F 15/16

(52) U.S. Cl. 709/203; 455/436

(57) ABSTRACT

Multimedia service contents are provided to user terminals in a wireless communication network, such as, a GPRS or UMTS network, by generating delivery packets that convey both the multimedia service contents and a corresponding service logic. These delivery packets are received and interpreted by means of an interpreter at the user terminals (client) to obtain presentation of the multimedia service contents and the interaction level between client and server according to the corresponding service logic. The multimedia contents can thus be presented interactively at the terminal while new services can be designed on the server side and made available to the user terminals without modifications being required on the terminal side.

### FIELD OF THE INVENTION

The present invention relates to a client-server system and a process therefor for providing services, in particular multimedia services, to wireless communication networks and more in particular for mobile networks including “smart” terminals, currently referred to as “Smartphones”. The techniques according to the invention are particularly suitable for services involving a high degree of interactivity.

### DESCRIPTION OF THE RELATED ART

Multimedia services are a continuously developing area. For instance, U.S. Pat. No. 6,341,316 concerns the delivery of web contents to mobile terminals. The solution disclosed therein is based on the synchronization of the contents delivered from the providers. Based on information from providers, synchronization modules compile instructions to synchronize the client with the providers. Applicants have noted that, for wireless systems in which the bandwidth available and the reception quality may greatly vary, synchronization of the web content to the client could be difficult and expensive. In addition, this solution does not provide support for real time interaction because every server feedback is postponed to the next synchronization.

Web services using XML (extended Markup Language) standards as a mechanism for exchanging information are nowadays widely employed. XML is a data format that represents data in a serialised form that can be transported over the network from one end point to another.

WO-A-01/03011 describes a system for coupling diverse client platforms and diverse information services. Content from any information services is first converted into a common format and then translated into a format suitable for the target platform. Translating the message from the common format into the format associated with the client device includes translating from a first markup language to a second markup language.

US2002/0107985 describes an arrangement for providing data services from a content provider via wireless mobile devices. The arrangement comprises a content provider that sends contents via the Internet to a regional server, which is connected to a plurality of local servers linked to a plurality of mobile devices via a wireless network. The regional server interprets the content by extracting presentation format information from the content received from the content provider and sends the content and the presentation format to the local servers.

US2002/0133568 describes a network information delivery system for providing information content to a user on an individual level. Individualized forwarding of information from one or more data sources to one or more defined destinations occurs in accordance with a set of rules. Data sources convert their data to XML streams that can be accessed by data destinations.

Additionally, a number of mobile web services are available from the Cape Clear Software and Softwired, Inc. under the trademark Cape Clear™. The related arrangements provide for the access to mobile web services, which enable mobile network operators and service providers to deliver content and interactive services with third party systems to their subscribers using an XML Web Services standard based approach.

A Java 2-based content management and delivery platform for mobile video streaming services is promoted under the trademark HotStreams® by Siemens. In this arrangement no specific software is applied on the client side, which makes use of a browser and a streaming player unit for video contents.

FIGS. 1 and 2 illustrate the flow chart diagrams of two known processes of service delivery to a final user (client).

The flow chart of FIG. 1 illustrates a typical process that is carried out in order to design and implement a multimedia service to be delivered via a network in the form, of downloadable application associated to a service. In FIG. 1, a new service is “designed” (step 100) based on multimedia contents and interactivity requirements (e.g., questions and answers or polls). This essentially leads to a textual description of the features and functions of the new service (step 102).

In a subsequent step 104, developers analyse the functional requirements of the new service in order to design and realise a new application that implements the new service. This leads to an application being developed, which is adapted to run on a target device such as a mobile device (step 106). The logic embodied in the application is fixed once the application is implemented, i.e., the logic is hard-coded.

In step 108 the new application adapted to realise the new service is made available (at the server side) for use by the client or end user (at the user side).

In step 110 the end user, typically after having subscribed to the new service, downloads the new application that realises the new service in order to access the multimedia content.

Applicants have observed that, when adopting the solution portrayed in FIG. 1, the service logic is fixed in the code of the application. In other words, the criteria for accessing the multimedia contents are fixed, often once for all, by the server, thereby decreasing the flexibility in implementing new services.

In the flow chart diagram of FIG. 2 (which refers to a browsing approach) the blocks designated 100 and 102 represent essentially the same functions as those already described with reference to FIG. 1.

Step 112 in FIG. 2 designates the step where the developers analyse the functional requirements of the service in order to design and realise a new WAP (Wireless Application Protocol) or Web server adapted to maintain the corresponding contents.

Finally, the block designated 114 indicates the steps where final users having a WAP/Web browser on their device and having subscribed to the new service, browse or “surf” the contents available on the server. Applicants have noted that, according to the process of service creation and deployment illustrated in FIG. 24 the service provider is generally not allowed to define and impose on the users a service logic, for instance in terms of a presentation sequence of a given object of contents before passing to a subsequent object.

### SUMMARY OF THE INVENTION

Applicants have observed that it would be advantageous to provide information content, especially if in the form of multimedia or interactive objects, to mobile terminals with the possibility of controlling how this content is actually perceived by the end user.

It is an object of the present invention to provide a system for providing interactive services on mobile terminals, in particular on “Smartphone”-type terminals, while permitting the service provider to realize a single application adapted to reside on the mobile device to receive both the contents and the service logic, thus permitting the service provider to define flexible and customized services while allowing an increased degree of interactivity for the end user (client). It is a further object of the present invention to provide a system permitting new interactive multimedia services to be devised, realized and provided by acting exclusively or almost exclusively at the server side.

The term Smartphone is generally used to characterize a wireless telephone set with special computer-enabled features not previously associated with ordinary cellular telephones, such as wireless Web access, local or remote data transfer between phone set and computers, LAN connectivity, and personal information management.

According to the present invention, this object is achieved by means of a method, system or terminal having the features set forth in the claims that follow.

Additionally, the invention relates to a computer program product directly loadable in the memory of a computer and including software code portions for performing the steps of the method of the invention and/or implementing a terminal for use in a system according to the invention when such a product is run on a computer.

The arrangement according to the invention leads to a delivery being in the form of delivery packets created specifically for a given end user with respect to a certain service according to a service logic that can be defined by the service provider.

The delivery packet, hereby referred also to as simply the packet, is a unit transferable to the client, which includes a collection of information contents such as, but not limited to, text, audio, images, videos, music files, links. Each packet is generally organised as a sequence of screens, each of the screens containing one or more information contents. The delivery packet generally contains a presentation logic and an interaction logic defined by the service logic. For instance, the service provider may decide the logic of presentation for the service while the end user is given the possibility of making selections among the contents being offered. Preferably, the delivery packet is written in a common markup language (ML) format, more preferably in an XML format.

In this context, the service logic refers in general to the sequence of processes/functions used to provide a specific service. In particular, the service logic can describe the sequence according to which the end user can access the contents, or define the restrictions on the client side such as the fact that the user is allowed only to go through the all contents in a delivery packet without the possibility of skipping some parts of it, e.g., the advertisements. The service logic can define also the level of client-server interactivity, for example the possibility to request details on a particular content, or to give questions and answers in a game session. In addition, the service logic can define the content presentation for the end user, for example the possibility to scroll from a screen to the next one. Therefore, the service provider defines the contents to be delivered as well as the service, e.g., presentation/interaction, logic to be implemented when a delivered packet is presented to the user.

According to one aspect of the invention, a client-server system is disclosed, which includes a content management platform, a server or server platform containing the services to be delivered, and delivery platform for delivering the services to a client, i.e., the end user.

In a preferred embodiment, the server platform comprises a common Delivery Application Logic (DAL), which defines the access to the external modules, such as the personalisation module, the localisation module or the content management module. The common DAL thus acts as a common Application Protocol Interface (API). In addition, the DAL acts as common server front end for the client. The common server front end accepts the client requests (PULL services) or the requests originating from internal or external entities (PUSH services). Each specific service is contained in a software cartridge that is installed on the common DAL. Therefore, when a new service is to be implemented, it is necessary only to implement a new cartridge that will be added to the common DAL. The service logic relative to a specific service is embodied in the cartridge associated to this service. By defining the service logic for each service, the service provider can impose restrictions when needed, i.e., when there is an advertising message or video that the server does not want to be skipped. Alternatively, the service provider can leave to the final user the possibility of free interaction within the contents of a delivery packet, or helping him by adding commands for the end user, like “next content” or “see details”. The possibility of “composing” such a service by using various contents formats significantly increases the value of the service.

When “designing” a service, the service provider usually negotiates with one or more content providers the delivery of contents in a format that is the most suitable for the service in question.

According to one of its aspects, the invention relates to a method of providing multimedia service contents to at least one terminal via a wireless network including the steps of:

generating delivery packets conveying both said service contents and a corresponding service logic,

transmitting said packets to said at least one terminal, and

receiving said packets at said at least one terminal and interpreting said packets to obtain presentation of said multimedia service contents at said at least one terminal according to said corresponding service logic whereby, both said contents and said corresponding service logic being on said at least one terminal, said multimedia service contents can be presented interactively at said at least one terminal.

The client is able to process the information received by interpreting the objects in the delivery packet by means of an interpreter based on the client side. The client is thus provided with an interpreter that receives the delivery packet, processes the contents and interprets the service logic to be applied to the contents. The client is provided also with a Presentation and Interaction module that receives from the interpreter the instructions on the contents to be displayed or listened to (in case of audio contents) and the corresponding service logic and executes them accordingly. The Presentation and Interaction module generally leverages the built-in capabilities of the terminal device, e.g., in case of a Smartphone or a PDA terminal, so as to allow the client to deal with different multimedia contents while guaranteeing uniformity in the user experience. Optionally, the client can include a user interface for the service management for the provisioning of the services to which the user has subscribed or for subscribing to new services.

One of the advantages of the present invention is the possibility for the client to work off-line after the download of a delivery packet. The collection of all activities that the end user make during fruition of a, delivery packet will be referred to as the micro-session. During a micro-session, the client application can be not connected, i.e., off-line, but contents can be shown according to the instructions defined in the service logic. Typically, the micro-session can be in the form of a sequence of screens and/or contents, such as a sequence being managed locally at the client level without any interruption or possible interfering by the server. This is particularly advantageous in the context of mobile terminal devices, when considering the possible existing limitations in terms of available bandwidth and continuous transmission signals. Alternatively, with a particular definition of the service logic, it can be possible to be re-connected to the server during or at the end of a micro-session, e.g., for submitting answers or results of a polls, or requesting details on a content.

### BRIEF DESCRIPTION OF THE DRAWINGS

The invention will now be described, by way of example only, by referring to the enclosed figures of drawing, wherein:

FIGS. 1 and 2 are flowchart diagrams relating to prior art arrangements for providing information contents according to an “application downloadable” approach and “browsing” approach, respectively,

FIGS. 3 and 4 are flowchart diagrams illustrating the basic principle of operation of the content implementation and delivery arrangement according to a preferred embodiment of the invention,

FIGS. 5 includes three portions, designated (a), (b) and (c), illustrating examples of delivery of multimedia services according to the the invention,

FIG. 6 is a block diagram of a personalization feature adapted to be associated with the arrangement according to the invention, and:

FIG. 7 is a block diagram showing a client-server system according to an embodiment of the invention.

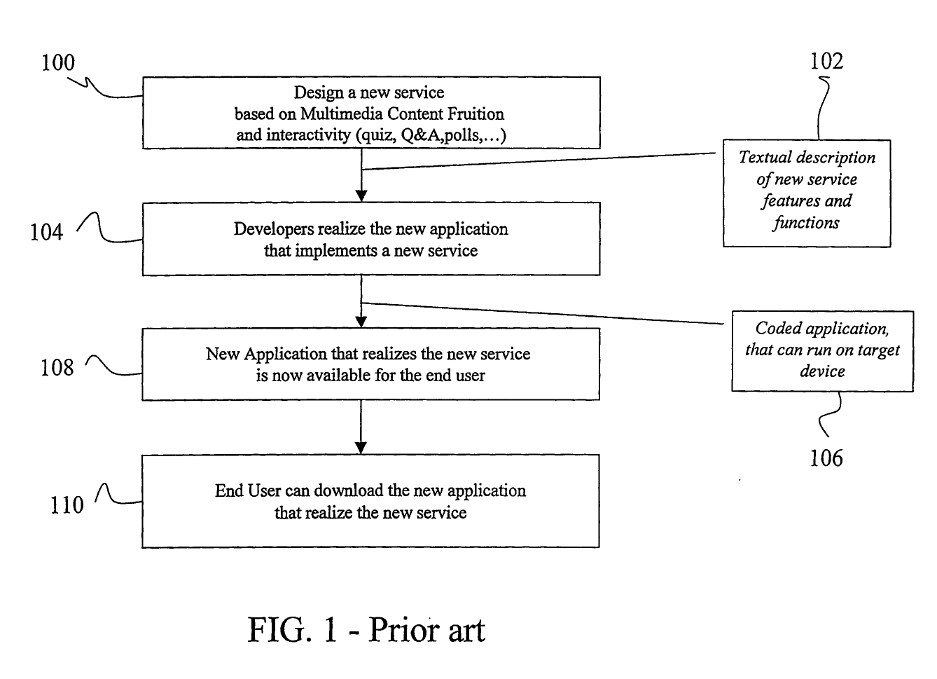

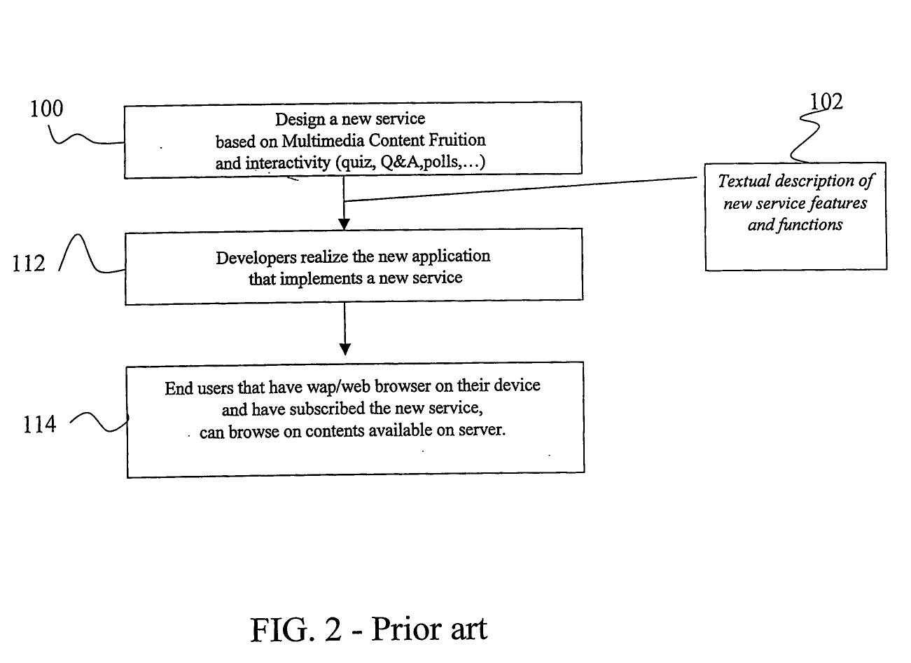

### DETAILED DESCRIPTION OF PREFERRED EMBODIMENTS OF THE INVENTION

Interpreter

The system disclosed herein relies on the provision of a so-called interpreter or interpreter module within a mobile terminal, in particular a Smartphone, in a mobile communication network.

Based on standard computer science terminology, an “interpreter” (also known as an interpretive program) is a program that translates and executes source language statements one line at a time. Specifically, an interpreter executes source code by reading it one line at a time and performing each instruction immediately. In that respect, an interpreter is different from a compiler, which does not execute the source code, but translates it into object code (or machine language) that is stored in a file and executed later. Essentially, an interpreter is a computer program module that changes the instructions in another program one at a time into a form that be easily understood by a computer or by another program/module.

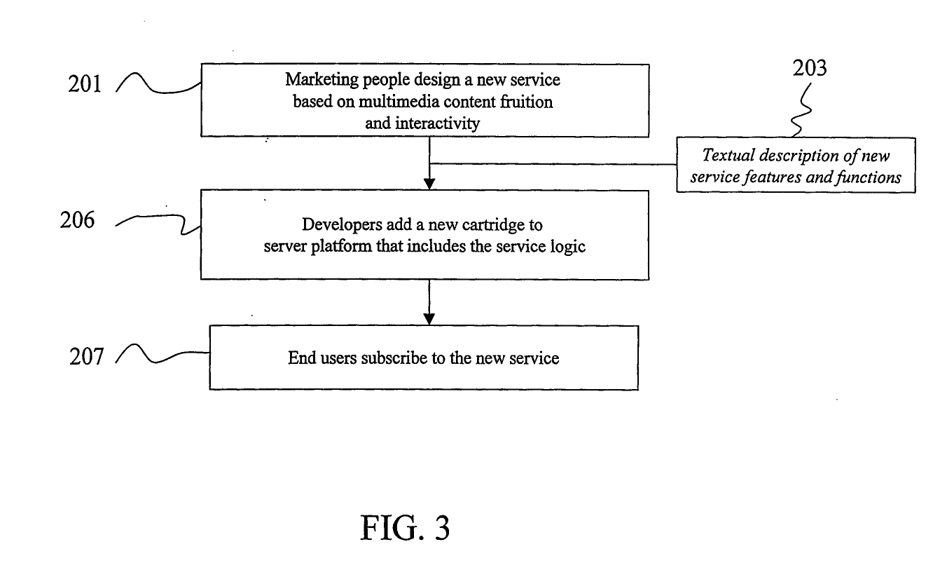

FIG. 3 illustrates the process related to the generation and implementation of a new service within a client-server system according to an embodiment of the invention. In the flow chart of FIG. 3, the block designated with 201 refers to the design of a new service based on multimedia contents and interactivity. This essentially leads to a textual description of the features and functions of the new service (step 203).

Reference number 206 designates a step wherein developers analyse the multimedia service requirements and implement a new software cartridge to be installed in a common DAL in the server platform. The new cartridge defines the service to be delivered and embodies the service logic. The service logic and the contents included in the cartridge are preferably transformed into an internal description language, i.e., a markup language (ML).

One of the main tasks of the server platform is to collect contents from the content providers and then package such contents with the related service logic in a single delivery packet using an internal description language. This packet must be interpreted and executed with related service logic by a client application that can run on the target device (such as the mobile terminal). Such an application comprises an interpreter, a presentation and interaction module and optionally a user interface for the service management.

When a new service has been designed and a new associated cartridge has been added to the server platform, a final user will be able to subscribe using for example a user interface that is part of the client application. This activity is described in step 207.

In case the application is not present on the terminal device, downloading of the client application can be carried out and will support every service already available or still to be implemented in the server.

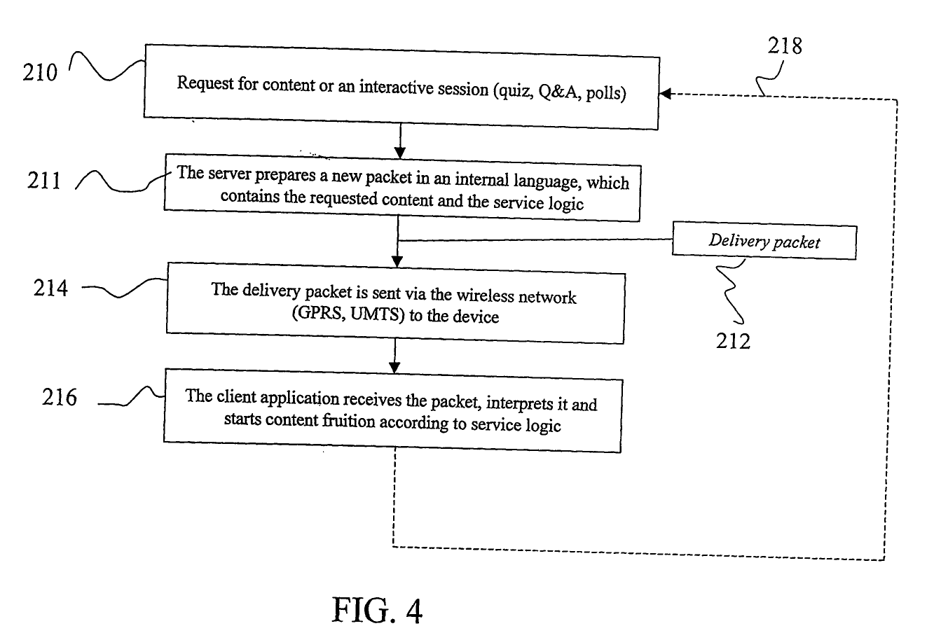

FIG. 4 schematically illustrates the process of creation of a new delivery packet within a given service implemented in the server platform. In step 210 the server receives the request for contents or an interactive session. The process of generation of new packets (step 211 in FIG. 4) by the service provider can be started as a consequence of either an external event, e.g., when new contents become available, in case of PUSH-type services or an interrogation or a request of the user in case of PULL-type services. When a service is active, the server can create a new delivery packet 212. An example of PUSH-type services is the request by a final user, e.g., by subscribing to a service, to receive a daily delivery packet containing the horoscope or the weather forecast.

In a step 214, the delivery packet 212 is sent to the mobile terminal of the end user through a wireless network, such as a GPRS or UMTS networks, which connects the end user to the server.

In a step 216 the client application receives the delivery packet 212. This delivery packet is interpreted by means of an interpreter present in the client and a presentation of the multimedia contents or an interactive session is started following the service logic.

Following or during the fruition of the delivery packet, the end user can make a request of contents or can interact with the server through an interactive session, e.g., a question and answer session. This may lead to the creation of a new delivery packet that will be sent to the user. This process step is referred in FIG. 4 as the loop 218.

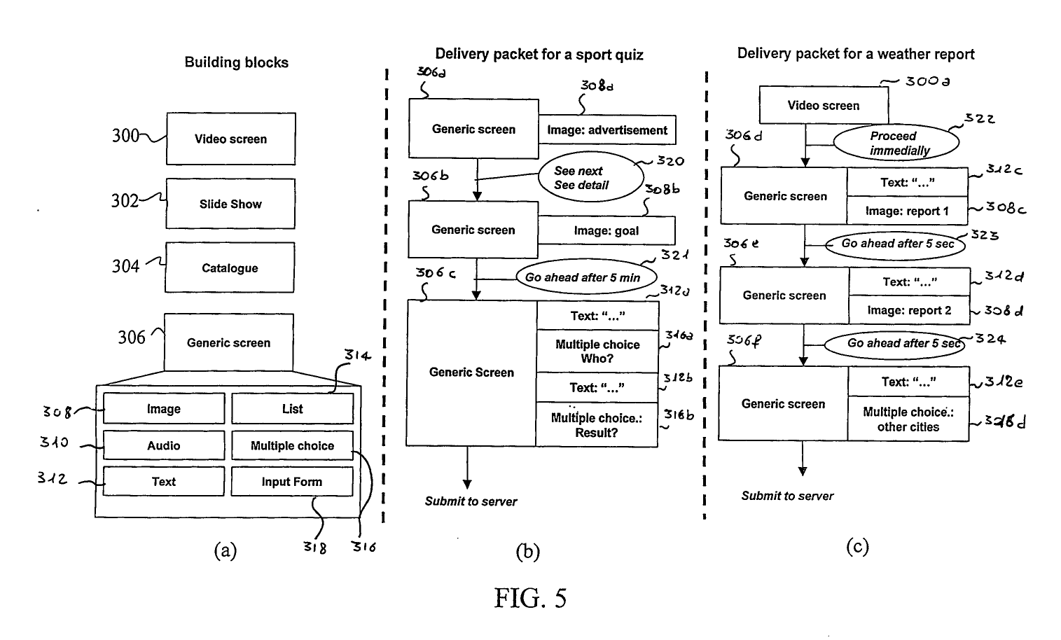

FIG. 5 illustrates an example of delivery of multimedia services that can be essentially regarded as comprising a set of basic building blocks or “bricks” adapted to be used and combined for providing different services embodying a given service logic.

The diagram of FIG. 5(a) shows an example of a multimedia (video, image, audio, text) service including the following basic blocks: a video screen 300, a slide show 302, and a catalogue 304 including the list of the possible different categories of services, e.g., sport, news, entertainment. The multimedia service of the example shown in FIG. 5(a) includes also a generic screen 306 containing at least one of the following objects: an image object 308, an audio object 310, a text 312, a list 314, a multiple choice (selection) option 316, and an input form 318.

The diagrams of FIGS. 5(b) and 5(c) show (in a purely exemplary manner) how the basic bricks or items contained in the service illustrated in FIG. 5(a) can be combined to produce a delivery packet associated to a question-based service such as a sport-related quiz [FIG. 5(b)] and a weather report [FIG. 5(c)]. In the delivery packet shown in the example of FIG. 5(b), the two images 308a and 308b shown in connection with generic screens 306a and 306b may be an advertisement image and an image pertaining to a sport event such as a goal, respectively. The first image 308a and second image 308b can be linked by a command of the service logic that allows the client to pass to the second image, indicated with step 320. The second image 308b is linked to the next object of the packet by a command 321 of the service logic, for example the instruction to proceed with the next screen 306c after 5 minutes. The sequence of texts 312a and 312b and multiple choice 314a and 314b of generic screen 306c may be a typical sequence where the client being provided with the service via his or her mobile terminal is asked questions in response to which the user submits the answers to the server. Depending on the answers that are submitted to the server, the server may in turn send to the user a second delivery packet according to a typically interactive pattern.

The diagram of FIG. 5(c) shows another example of a delivery packet comprising a possible sequence of objects for providing a weather report service. In this case, the first video screen 300a may include a general presentation of the service in connection with an advertisement image. The subsequent generic screens 306d and 306e may represent a sequence of text items 312c and 312d which are associated to images 308c and 308d providing the information on the weather forecast.

The delivery packet schematically illustrated in FIG. 5(c) may also include a generic screen 306f including a text item 312e and a multiple choice item 316c that permits the user to submit to the server a request of presentation of data pertaining to the weather report of another geographical area or another day. Depending on the request expressed by means of such an option, the server will send to the client a new delivery packet.

Screens of FIG. 5(c) are linked one to another subsequently according to a service logic that is represented in this example by instructions 322 to 324.

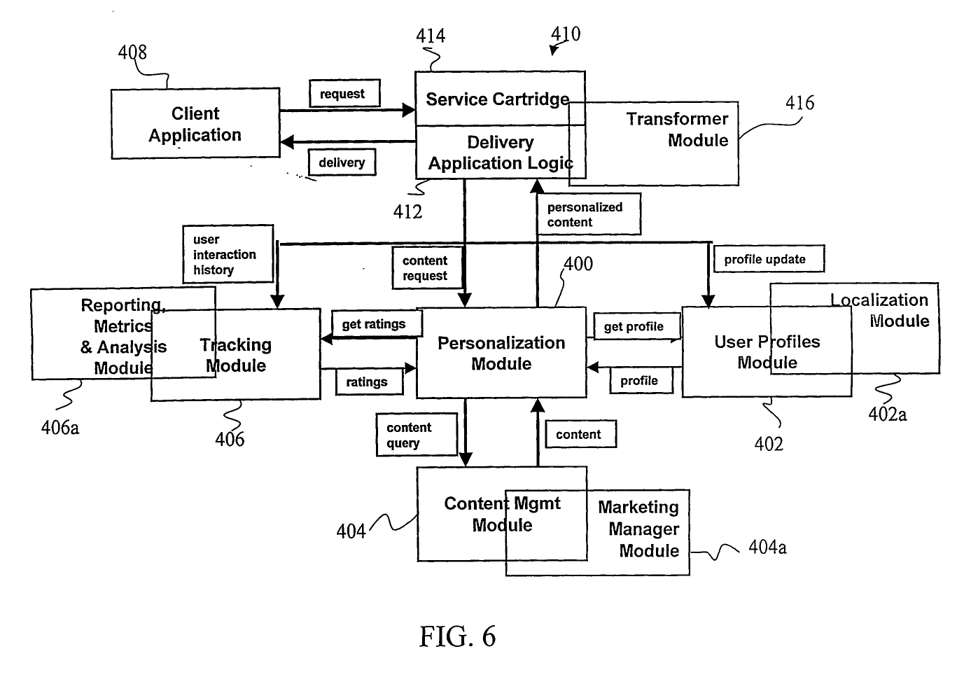

The functional block diagram of FIG. 6 is intended to illustrate the functional features of the architecture comprising the client-server system according to an embodiment of the present invention. A server system 410 comprises a common delivery application logic (DAL) 412 and one or more cartridges 414, each comprising a service logic that is distinctive of each service.

According to an arrangement known per se, a personalization module 400 is intended to co-operate with a user profile module 402 containing the profiles of different users and in turn adapted to cooperate with a localization module 402a.

Essentially, the localization module 402a is adapted to derive from the wireless network (GORS, UMTS) information concerning the current location of the end user in order to possibly tailor the services provided as a function of such a location, e.g., by providing a weather report pertaining to the area where the end user is located.

The personalization module 400 also interacts with a content management module 404 that provides the contents. A more specific content module, a marketing manager module 404a, can be associated to the content management module 404. The marketing management module manages the advertisements and more generally the marketing campaigns.

Additionally, the personalization module 400 interacts with a tracking module 406 having associated a reporting, metrics and analysis module 406a. The tracking module 406 records the user/client behaviour, while the reporting, metrics and analysis module 406a generates reports and off-line analyses for mapping the interest of the users to a specific service.

The personalization module 400 obtains from the user profile module 406 profile information on the basis of respective “get profile” queries. Similarly, the personalization module 400 obtains information contents from the contents management module 404 following some given content queries while also obtaining rating information from the tracking module 406 as a result of corresponding “get ratings” queries.

In the block diagram of FIG. 6, reference 408 designates the client application having the nature of a “single” application for a plurality of different services. The client application 408 receives delivery packets from the server 410 that can be the result of requests, in a PULL-type service, which are submitted from the module 408 to the server 410 through the wireless network.

Reference 416 designates a transformer module that transforms (in manner known per se) the delivery packets into the format that is most suitable for reception, interpretation and presentation by the client application 408. Preferably, the format of the delivery packets is written in a common markup language (ML) format, more preferably in an XML format.

The DAL 412 obtains personalized contents from the personalization module 400 as a result of corresponding content request queries being submitted by the server 410 to the personalization module 400.

Additionally, the server 412 sends towards the user profile module 402 and the tracking module 406 information contents concerning the profile update and the user interaction history.

Table 1 reports an example of a PULL-type service according to the architecture illustrated in FIG. 6 for providing a weather report. It describes the instructions included in the server, i.e., in a cartridge associated to the specific service and in the DAL.

TABLE 1

| | |
|---|---|
| 1. | Get Profile of the user that requested the service |
| | “weather report”; |
| 2. | Request User Position to the Localization Module; |
| 3. | Request of content regarding the weather forecast |
| | to Content Management Module for user position; |
| 4. | Request of a list of advertisements to the |
| | Marketing Manager Module; |
| 5. | Request of personal data of the user for |
| | personalization of the advertisements to the |
| | personalization module based on the user profile; |
| 6. | Select and retrieve an advertisement (Ad) from the |
| | Advertisements List from the personal profile; |
| 7. | Request of transformation and packaging to the |
| | Transformer for the contents and Ad according to |
| | Weather Report service logic. For example, first |
| | show the Ad without the option for the user to |
| | skip it; then automatically, after 3 seconds, move |
| | to the first weather report image; user must click |
| | “next” to view the next image, the back option to |
| | move to the previous image is available when |
| | applicable; |
| 8. | Send to user the delivery packet. |

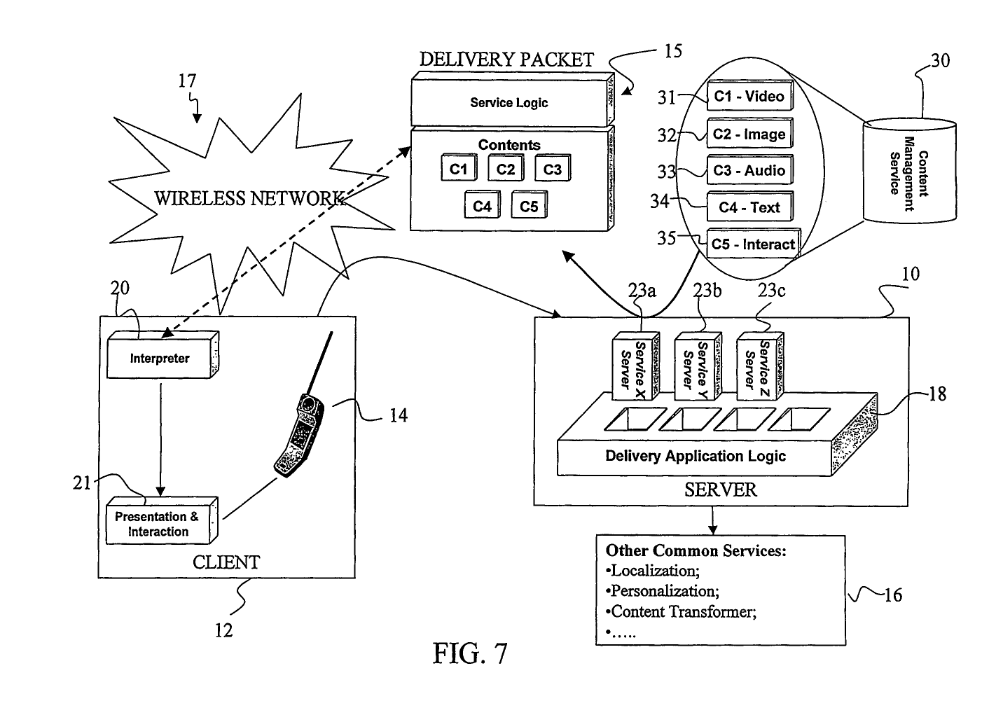

The block diagram of FIG. 7 schematically illustrates a client-server system according to an embodiment of the present invention. A server platform 10 is arranged to deliver multimedia services to a plurality of mobile terminals 14 (e.g. of the “smartphone” type) via a wireless communication network 17 such as a GPRS or a UMTS. As it is well known, GPRS and UMTS are acronyms for General Packet Radio Service and Universal Mobile Telecommunication System, respectively.

The server 10 is adapted to interact via one or more links with other common services 16, such as user localization, content personalization or content transformation. Within the server platform 10, the delivery application logic (DAL) 18 is associated to a plurality of add-on software cartridges 23a, 23b, 23c, each identifying a service. The cartridges convey the “construction” that leads the basic blocks 31-35 in the content management service 30 to be co-ordinated to generate the delivery packets to be delivered to the client 12, i.e., to the mobile terminal 14 of the end user.

The contents are maintained in a generic contents management system 30 containing data/objects which are indicated in an exemplary manner in FIG. 7 with units 31-35. The combination of data/objects can be specific to a given service. Quite frequently, however, such data/objects are adapted to be shared by a plurality of services. The contents are multimedia objects of any kind such as video sequences, images, audio or merely text.

The client 12 comprises an interpreter module 20 and a presentation and interaction module 21.

It will thus be appreciated that the arrangement disclosed herein permits a service provider to realize a single application adapted to be hosted on a mobile device adapted to receive both the contents and the service logic (including the interaction criteria with the user) thereby permitting new multimedia services to be designed and realized by acting on the server side only.

In the server 10, the common layer DAL 18 is shared by all the services which are implemented, thus permitting the integration and use of additional services such as localization, user profile management with the possibility of applying personalization criteria, management and transformation of contents to adapt them to the specific terminal type used by a certain client. It will be appreciated that with the server platform herein disclosed implementation time of new services can be significantly reduced. Furthermore, identification of services as add-on cartridges in a common layer of the server allows a relatively large flexibility in the definition of multimedia and interactive services. The degree of a multimedia flexibility ensured by the service will depend primarily on the terminal capabilities, whereby services may be different for terminals having different capabilities. No specific requirements are set in terms of available bandwidth.

The packets are delivered to the client by using a standard transportation protocol. By way of example, this could be an MMS protocol, even though protocols such as HTTP/HTTPS are preferred as these increase the degree of interactivity.

Examples of languages suitable for developing the client application are J2ME-MIDP 1.0, pJava, or C++. A preferred choice for the language to implement the client terminal is J2ME-MIDP1.0. The server is preferably based on a fully object-oriented arrangement such as J2EE.

The arrangement disclosed herein permits new services with high interactivity contents to be created in a relatively short lapse of time (particularly in the matter of days) and at very small costs. In fact, the only requirement is realizing the add-on cartridge in the server and defining the service template, i.e., the transportable language format. The delivery format is preferably common to substantially all services and is an XML format. The user is not generally required to download a new application in order to be delivered a new service, this being true for a wide variety of services.

The arrangement disclosed is fully compatible with the GPRS or UMTS data channel, this data channel being regarded at present as a preferred choice as the communication channel.

Of course, without prejudice to the underlying principles of the invention, the details and the embodiments may vary, also significantly, with respect to what has been described and shown, by way of example only, without departing from the scope of the invention as defined by the annexed claims.

1-26. (canceled)

27. A method of providing multimedia service contents to at least one terminal via a wireless network including the steps of:
generating delivery packets conveying both said service contents and a corresponding service logic;
transmitting said packets to said at least one terminal; and
receiving said packets at said at least one terminal and interpreting said packets to obtain presentation of said multimedia service contents at said at least one terminal according to said corresponding service logic, whereby both said contents and said corresponding service logic being on said at least one terminal, said multimedia service contents can be presented interactively at said at least one terminal.

28. The method of claim 27, comprising the step of defining said corresponding service logic as a delivery application logic common to a plurality of multimedia services in combination with at least one add-on cartridge specific to a given service.

29. The method of claim 28, further comprising the steps of:
providing a server adapted to transmit said delivery packets to said at least one terminal; and
generating a new multimedia service for the delivery to said at least one terminal by generating a respective add-on cartridge.

30. The method of claim 27, comprising the step of providing at said at least one terminal at least one presentation and interaction module.

31. The method of claim 27, further comprising the step of providing at said at least one terminal the service logic permitting at least one sequence of screens to be managed at said at least one terminal.

32. The method of claim 27, further comprising the steps of:
providing a plurality of information content building blocks adapted to be shared by a plurality of multimedia services, wherein said service logic is adapted to co-ordinate differently said basic building blocks for different multimedia services.

33. The method of claim 27, further comprising the steps of generating said delivery packets on the basis of a service standard template.

34. The method of claim 33, wherein said service template is defined in a markup language such as XML.

35. The method of claim 27, comprising the step of using a mobile communications network as said wireless network.

36. The method of claim 35, comprising the step of selecting said mobile communications network as one of a GPRS and a UMTS network.

37. The method of claim 36, further comprising the step of transmitting said delivery packets via the data channel of said one of a GPRS and a UMTS network.

38. The method of claim 27, further comprising the step of transmitting said delivery packets via a transport protocol selected from the group consisting of MMS, HTTP and HTTPS.

39. The method of claim 27, further comprising the steps of:
providing said at least one terminal with a presentation and interaction module; and
providing said at least one terminal with an interpreter module for mapping the actions and contents conveyed by the delivery packets onto said presentation and interaction module.

40. A client-server system for providing multimedia service contents to at least one terminal via a wireless network comprising:
a server configured for generating delivery packets conveying both said multimedia service contents and a corresponding service logic;
said wireless network for transmitting said packets to said at least one terminal;
said at least one terminal being configured for receiving said packets and interpreting said packets to obtain presentation of said multimedia service contents at said at least one terminal according to said corresponding service logic, whereby both said contents and said corresponding service logic being on said at least one terminal, said multimedia service contents can be presented interactively at said at least one terminal.

41. The system of claim 40, wherein said server is configured for defining said corresponding service logic as a delivery application logic common to a plurality of multimedia services in combination with at least one add-on cartridge specific to a given service.

42. The system of claim 41, wherein said service is configured for generating a new multimedia service for delivery to said at least one terminal by generating a respective add-on cartridge.

43. The system of claim 40, wherein said server is configured for providing a plurality of service content building blocks adapted to be shared by a plurality of said multimedia services, wherein said service logic is adapted to coordinate differently said basic building blocks for different multimedia services.

44. The system of claim 40, wherein said server is configured for generating said packets on the basis of a service standard template.

45. The system of claim 44, wherein said service template is defined in a markup language such as XML.

46. The system of claim 40, wherein said wireless network is a mobile communications network.

47. The system of claim 46, wherein said mobile communications network is one of a GPRS and a UMTS network.

48. The system of claim 47, wherein said delivery packets are transmitted to said at least one terminal via the data channel of said one of a GPRS and a UMTS network.

49. The system of claim 40, wherein said delivery packets are transmitted to said at least one terminal via a transport protocol selected from the group consisting of MMS, HTTP and HTTPS.

50. A terminal for use as said at least one terminal in the system of claim 40, said terminal including an interpreter module for processing the actions and contents conveyed by said packets onto a presentation and interaction module.

51. A computer program product directly loadable in the memory of a computer and including software code portions for performing the steps of claim 27, when said product is capable of being run on a computer.

52. A computer program product directly loadable in the internal memory of a computer and comprising software code portions for implementing the terminal of claim 50, when said product is capable of being run on a computer.
